(19) United States
(12) Patent Application Publication
(10) Pub. No.: US 2013/0325836 A1
(43) Pub. Date: Dec. 5, 2013

(54) Systems and Methods for Providing Context Search Filtering

(71) Applicant: The Procter & Gamble Company, Cincinnati, OH (US)

(72) Inventors: Paul Vincent Gerwe, Sharonville, OH (US); Mark Rozum, Pittsburgh, PA (US); Je Chul Kim, Pittsburgh, PA (US)

(21) Appl. No.: 13/910,334

(22) Filed: Jun. 5, 2013

Related U.S. Application Data
(60) Provisional application No. 61/655,592, filed on Jun. 5, 2012.

(51) Int. Cl. G06F 17/30

(52) U.S. Cl. CPC G06F 17/30011
USPC 707/706

(57) ABSTRACT

Included are embodiments for providing context search filtering. Some embodiments include receiving a search term for locating a document on a closed network, utilizing a closed network search algorithm to locate a plurality of documents on the closed network, and creating identifiers for the plurality of documents from the closed network, the identifiers being arranged in a predetermined order. Similarly, some embodiments include determining whether any of the identifiers relate to a common source and in response to determining that at least two of the identifiers relate to the common source, reorganizing the identifiers to incorporate the at least two identifiers under a common heading. Still some embodiments include providing a user interface that includes the common heading and at least a portion of the identifiers.

### FIELD OF THE INVENTION

The present application relates generally to systems and methods for providing context search filtering and specifically to embodiments for filtering and/or organizing document search results on a closed network.

### BACKGROUND OF THE INVENTION

On many closed networks, such as corporate networks, searches may be performed utilizing a search tool, similar to a search engine. Oftentimes these searches may reveal numerous documents that are stored at various locations on the closed network. While the current searching functionality may locate the desired document, oftentimes the search results are so voluminous, the user cannot locate the desired document within the search results.

### SUMMARY OF THE INVENTION

Included are embodiments for providing context search filtering. Some embodiments include receiving a search term for locating a document on a closed network, utilizing a closed network search algorithm to locate a plurality of documents on the closed network, and creating identifiers for the plurality of documents from the closed network, the identifiers being arranged in a predetermined order. Similarly, some embodiments include determining whether any of the identifiers relate to a common source and in response to determining that at least two of the identifiers relate to the common source, reorganizing the identifiers to incorporate the at least two identifiers under a common heading. Still some embodiments include providing a user interface that includes the common heading and at least a portion of the identifiers.

Also included are embodiments of a computing device. Some embodiments of the computing device include a memory component that stores logic that, when executed by the system, causes the system to receive a search term for locating a document on a closed corporate network, utilize a closed corporate network search algorithm to locate a plurality of documents on the closed corporate network, and determine network locations for the plurality of documents from the closed corporate network. In some embodiments, the logic causes the system to create user-selectable links for the network locations, the user-selectable links being arranged in a predetermined order and determine whether any of the network locations relate to a common network location. Additionally, in response to determining that at a portion of the network locations relate to the common network location, some embodiments of the logic cause the system to reorganize the user-selectable links to incorporate the user-selectable links associated with the portion of the network locations under a common heading. Additionally, in some embodiments, the logic causes the system to provide a user interface that includes the common heading and at least a portion of the user-selectable links associated with the common network location.

Also included are embodiments of a non-transitory computer-readable medium. Some embodiments of the non-transitory computer-readable medium include logic that, when executed by a computing device, causes the computing device to receive a search term for locating a document on a closed corporate network, utilize a search algorithm to locate a plurality of documents, and determine network locations for the plurality of documents. In some embodiments, the logic causes the computing device to create user-selectable links for the network locations, the user-selectable links being arranged in a predetermined order and determine whether any of the network locations relate to a common network location. In response to determining that at a portion of the network locations relate to the common network location, some embodiments cause the computing device to reorganize the user-selectable links to incorporate the user-selectable links associated with the portion of the network locations under a common heading. In still some embodiments, the logic causes the computing device to provide a user interface that includes the common heading and at least a portion of the user-selectable links associated with the common network location.

### BRIEF DESCRIPTION OF THE DRAWINGS

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate various embodiments described herein, and together with the description serve to explain the principles and operations of the claimed subject matter.

FIG. 1 depicts a closed network environment for providing context search filtering, according to embodiments disclosed herein;

FIG. 2 depicts a searching device for providing searching and/or filtering of search results, according to embodiments disclosed herein;

FIG. 3 depicts a user interface for providing searching functionality on a closed network, according to embodiments disclosed herein;

FIG. 4 depicts a user interface for providing filtered search results on a closed network, according to embodiments disclosed herein;

FIG. 5 depicts a user interface for providing filtered search results for a common source, according to embodiments disclosed herein;

FIG. 6 depicts a user interface for providing sources of search results, according to embodiments disclosed herein;

FIG. 7 depicts a user interface for providing primary filtered search results, according to embodiments disclosed herein;

FIG. 8 depicts a user interface for viewing all search results from a source, as selected from a filtered list, according to embodiments disclosed herein;

FIG. 9 depicts a user interface for providing top search results from a common source, according to embodiments disclosed herein;

FIG. 10 depicts a user interface for providing all results from a common source, according to embodiments disclosed herein; and

FIG. 11 depicts a flowchart for providing content filtered searching, according to embodiments disclosed herein.

### DETAILED DESCRIPTION OF THE INVENTION

In many corporate environments, system files may be provided via a corporate intranet system or corporate network. The intranet system may operate as a closed network, with a search engine that locates files, intranet pages, and/or other information. As the intranet system is often dominated by files (as opposed to an internet environment, which is dominated by web pages), it is often difficult to determine network locations of the desired files among a large number of files from a common location.

Accordingly, embodiments disclosed herein may be configured to provide search engine intranet filtering that retrieves search results and then filters those results, based on the location of the file. As an example, an intranet search engine may receive a keyword search from a user for a document. The search may be performed and may result in numerous documents that include the keywords. Embodiments disclosed herein first determine the source of each of the documents revealed in the search and then group the search results based on that determined location. The groups of search results may then be organized according to the original order of the search results or according to the number of results from each source.

As an example, a keyword search may yield a first result from source A, a second result from source B, a third result from source A, a fourth, fifth, and sixth result from source C and a seventh result from source D. In some embodiments, the results may be ordered with the first result and the third result as an expandable first listing, the second result as a second listing, the fourth, fifth, and sixth result as a third expandable listing, and the seventh result as a fourth listing. Similarly, in some embodiments, the fourth, fifth, and sixth results may be ordered as a first expandable listing, the first and third result as a second expandable listing, the second result as a third listing, and the seventh result as a fourth listing.

Accordingly, the search results may be grouped according to the source and/or location of the search result on the closed network. The groups may then be organized for providing the most relevant search results to the user.

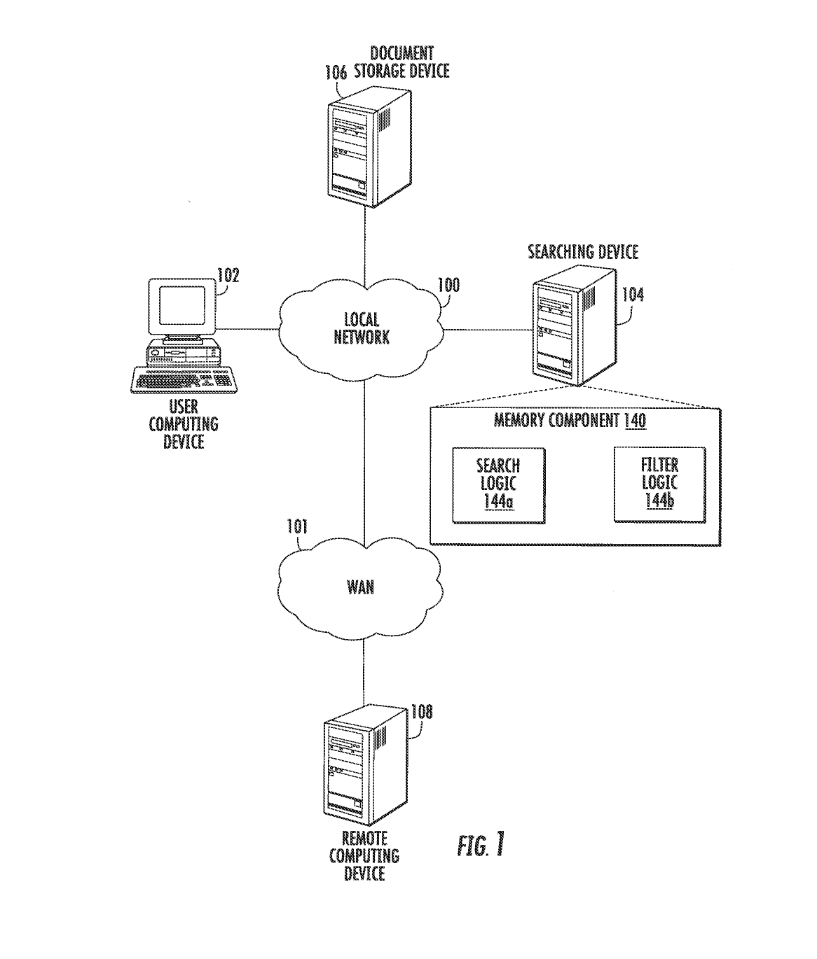

Referring now to the drawings, FIG. 1 depicts a closed network environment for providing context search filtering, according to embodiments disclosed herein. As illustrated, a local network 100 may be part of a closed corporate network, and/or other intranet configuration that communicates with a plurality of authorized computing devices. Coupled to the local network 100 is a wide area network 101. The wide area network 101 may include the internet, a mobile communications network, a satellite network, a public service telephone network (PSTN) and/or other network for facilitating communication between numerous devices, regardless of affiliation or authorization. Because the wide area network 101 is coupled to the local network 100, the wide area network 101 may be part of the closed network and/or an open network, depending on the required authentication for accessing a computing device. Additionally, the wide area network 101 may be coupled to a remote computing device 108, which may include a server, a personal computer, server, and/or other computing device.

Similarly, the local network 100 may be coupled to a user computing device 102, a searching device 104, and a document storage device 106. The searching device 104 may utilize a closed corporate network search algorithm or other search algorithm and may be configured as a search engine server or other server, personal computer, mobile computing device, etc. Regardless, the searching device 104 may include search logic 144a and filter logic 144b. The search logic 144a may be configured to cause the searching device 104 to perform one or more searches for sites, documents, people, and/or other items on the local network 100 (and/or wide area network 101). Similarly, the filter logic 144b may be configured to cause the searching device 104 to analyze and filter the search results, as described herein. Additionally the document storage device 106 may be configured as a server, personal computer, or other computing device and may store one or more sites and/or documents that may be located by the searching device 104.

Accordingly, the user computing device 102 may request for a search to be performed via a user interface. The search request may be sent to the searching device 104, which may perform a search of the document storage device 106. The search may identify one or more sites, documents, and/or people, which may be stored on the document storage device 106. Once the search results are identified, identifiers, which may take the form of user-selectable links, may be created. Additionally, the searching device 104 may utilize the filter logic 144b to determine a display order for the search results. This may include determining which of the search results are most relevant to the search and identifying which of the search results that are associated with a common source. The common source may include a common site, a common document, a common corporate group, etc. Those search results with a common source may be grouped together and provided accordingly. The groups may then be provided according to which search result was listed first, which group includes the most search results and/or according to other criteria. This allows for more efficient location of the desired search result because the search results are provided in a format that removes at least a portion of repetitive sites, documents, and/or people.

It should be understood that while the searching device 104, the document storage device 106, and the remote computing device 108 are depicted as a server and the user computing device 102 and the user computing device 102 are depicted as personal computers, these are merely examples. More specifically, the user computing device 102, the searching device 104, the document storage device 106, and the remote computing device 108 may be any type of computing device (e.g. mobile computing device, tablets, personal computer, mobile phone, personal digital assistant, etc.). Additionally, while each of these devices 102-108 is depicted in FIG. 1 as single pieces of hardware, this is also an example. Each of the devices 102-106 may represent a plurality of servers, personal computers, laptop computers, mobile phones, tablets, etc.

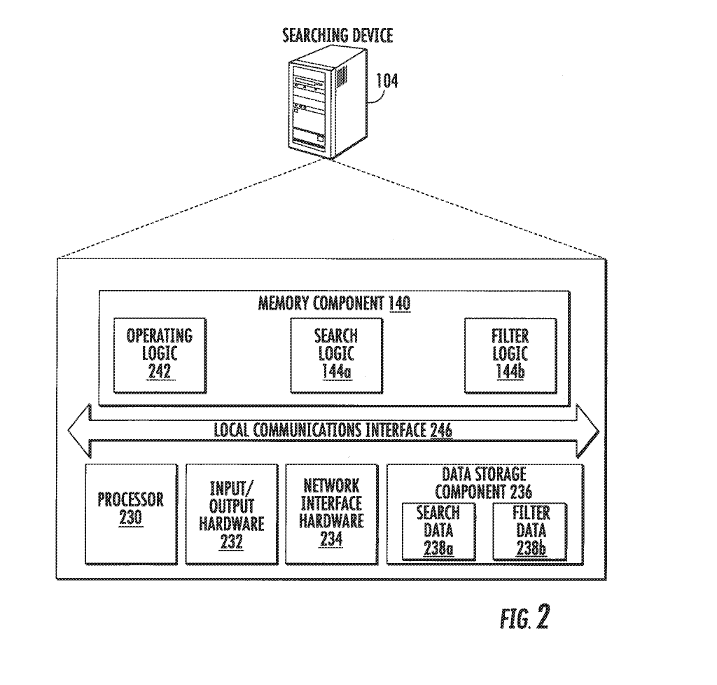

FIG. 2 depicts a searching device 104 for providing searching and/or filtering of search results, according to embodiments disclosed herein. In the illustrated embodiment, the searching device 104 includes a processor 230, input/output hardware 232, network interface hardware 234, a data storage component 236 (which stores search data 238a and filter data 238b), and the memory component 140. The memory component 140 may be configured as volatile and/or nonvolatile memory and, as such, may include random access memory (including SRAM, DRAM, and/or other types of RAM), flash memory, registers, compact discs (CD), digital versatile discs (DVD), and/or other types of non-transitory computer-readable mediums. Depending on the particular embodiment, these non-transitory computer-readable mediums may reside within the searching device 104 and/or external to the searching device 104.

Additionally, the memory component 140 may be configured to store operating logic 242, the search logic 144a, and the filter logic 144b, each of which may be embodied as a computer program, firmware, and/or hardware, as an example. A local communications interface 246 is also included in FIG. 2 and may be implemented as a bus or other interface to facilitate communication among the components of the searching device 104.

The processor 230 may include any processing component operable to receive and execute instructions (such as from the data storage component 236 and/or memory component 140). The input/output hardware 232 may include and/or be configured to interface with a monitor, keyboard, mouse, printer, camera, microphone, speaker, and/or other device for receiving, sending, and/or presenting data. The network interface hardware 234 may include and/or be configured for communicating with any wired or wireless networking hardware, a satellite, an antenna, a modem, LAN port, wireless fidelity (Wi-Fi) card, WiMax card, mobile communications hardware, and/or other hardware for communicating with other networks and/or devices. From this connection, communication may be facilitated between the searching device 104 and other computing devices.

Similarly, it should be understood that the data storage component 236 may reside local to and/or remote from the searching device 104 and may be configured to store one or more pieces of data for access by the searching device 104 and/or other components. In some embodiments, the data storage component 236 may be located remotely from the searching device 104 and thus accessible via the local network 100. In some embodiments however, the data storage component 236 may merely be a peripheral device, but external to the searching device 104.

Included in the memory component 140 are the operating logic 242, the search logic 144a and the filter logic 144b. The operating logic 242 may include an operating system and/or other software for managing components of the searching device 104. Similarly, the search logic 144a may be configured to cause the searching device 104 to perform a search on the local network 100 and/or on the wide area network 101.

It should be understood that the components illustrated in FIG. 2 are merely exemplary and are not intended to limit the scope of this disclosure. While the components in FIG. 2 are illustrated as residing within the searching device 104, this is merely an example. In some embodiments, one or more of the components may reside external to the searching device 104. It should also be understood that, while the searching device 104 in FIGS. 1 and 2 is illustrated as a single system, this is also merely an example. In some embodiments, the content providing functionality is implemented separately from the advertisement functionality, which may be implemented with separate hardware, software, and/or firmware.

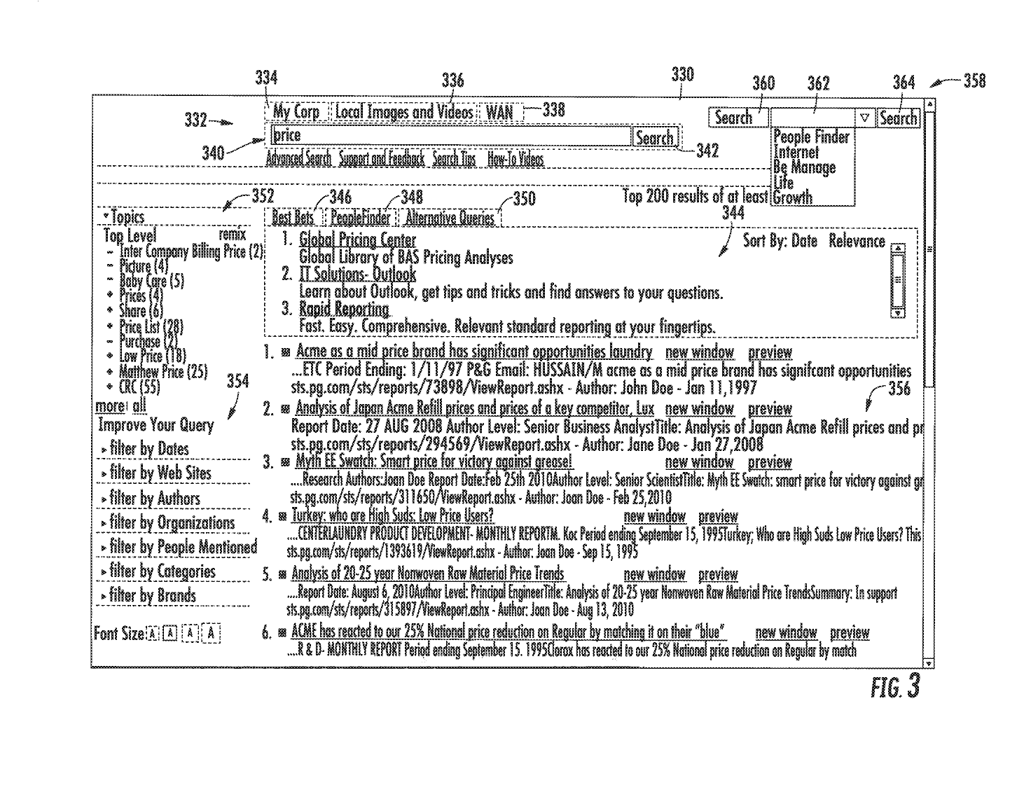

FIG. 3 depicts a user interface 330 for providing searching functionality on a closed network, according to embodiments disclosed herein. As illustrated, the user interface 330 includes a search area section 332. The search area section 332 includes a corporation tab 334, a local images and videos tab 336, and a wide area network tab 338. Also included are a keyword section 340 and a search option 342.

Specifically, the user may input a keyword string, Boolean operator, and/or a proximity operator into the keyword section 340. Additionally, in response to selection of the corporation tab 334, a search of the closed network may be performed. Similarly, in response to selection of the local images and videos tab 336, a search for images and videos on the closed network may be performed. In response to selection of the wide area network tab 338, a search on the wide area network 101 may be performed.

Also included are a topics section 352 and a query section 354. Specifically, in response to initiating a search for the keyword “price,” the topics section 352 may be provided. The topics section 352 may provide one or more topics that relate to the search results. Specifically, the keyword search may be related to one or more topics and/or related terms. The query section 354 may include one or manual filtering criteria by which the user may filter the search results.

Also included are an alternative function section 344 and a search results section 356. The alternative function section 344 may include a plurality of alternative functions that may be available. The alternative function section 344 includes a best bets tab 346, a people finder tab 348, and an alternative queries tab 350. The best bets tab 346 provides one or more other resources for locating the desired search result. Similarly, the people finder tab 348 may be selected to perform a person search to locate information on people associated with the keyword. An alternative queries tab 350 provides other resources for locating the desired search results. Similarly, the search results section 356 includes a plurality of different search results related to the keyword. As illustrated, a title, author, date, source, and/or other options may be provided for each of the search results.

The user interface 330 also includes a search widget 358. The search widget 358 may include a keyword section 360 and a category section 362. Similar to the keyword section 340, the keyword section 360 may be configured for receiving a keyword from a user. The category section 362 may be utilized for narrowing the search according to a predetermined category of subject matter. The search option 364 may initiate the search.

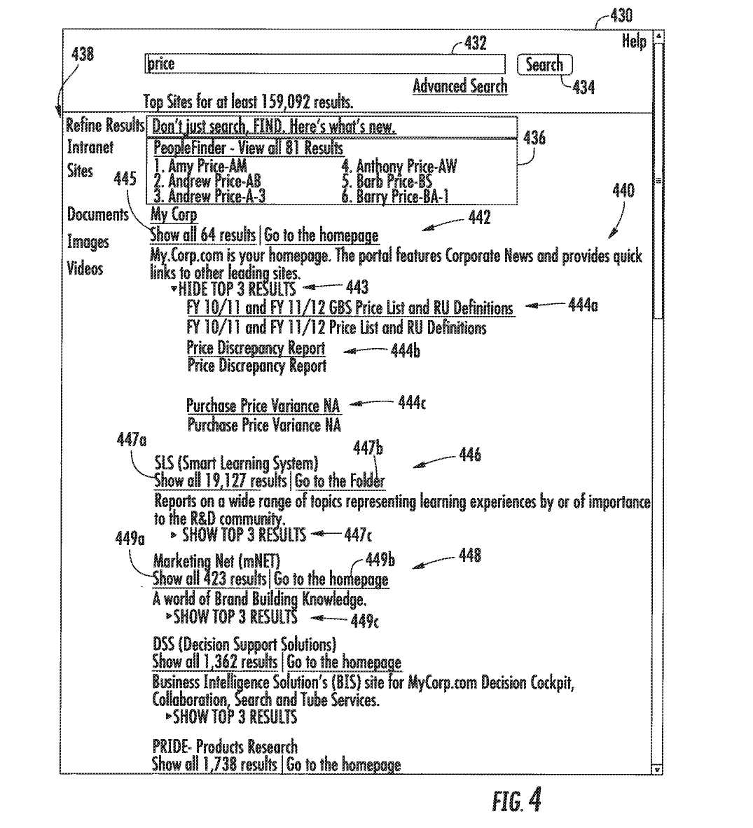

As illustrated in FIG. 3, the searching device 104 on a closed network may identify numerous search results. Additionally, because the closed network is often a closed corporate network, the search results often identify documents located within the closed network. As a consequence, each of the documents and/or location where the document resides may create multiple search results, which are depicted in FIG. 3. While the depth of search results may prove valuable in locating a document the user desires, the sheer number of search results may also become overwhelming to the point of losing effectiveness. As a result, embodiments described with regard to FIG. 4 provide context based grouping of the search results to provide the user with a greater ability to eliminate irrelevant results.

FIG. 4 depicts a user interface 430 for providing filtered search results on a closed network, according to embodiments disclosed herein. As illustrated, the user interface 430 includes a keyword section 432 and a search option 434. As described above, in response to input of a search term and selection of the search option 434, the search may be initiated.

Additionally, in response to initiation of the search, the user interface 430 may include a people finder section 436. The people finder section 436 may be utilized for using the received search term to locate people on the closed network. The people finder section 436 includes a listing of the people on the closed network that share at least one piece of information related to the keyword.

Also included is a refine search results section 438. The refine search results section 438 may be configured to provide at least one filtering option for a user to manually refine and/or filter the received search results. The user interface 430 also includes a search results section 440. The search results section 440 includes a source identifier 442, which is utilized as a heading for at least two identifiers of corresponding search results that share a common source. Specifically, the top result revealed in the search is a document entitled “FY 10/11 and FY 11/12 Price list and RU Definitions” that is identified with an identifier 444a. This document was located at my.corp.com. Additionally, there are 63 other search results from my.corp.com. As such, the searching device 104 may identify the top three (or other predetermined subset) results, as indicated with the identifier 444a and identifiers 444b and 444c. The source identifier 442 may also be utilized as a user-selectable link to the my.corp.com homepage. Additionally, a hide option 443 may be provided to hide the top results. A results option 445 may be provided for providing the user with all search results from the my.corp.com site. Also included are search results from other sources, as identified by identifiers 446 and 448. Specifically, identifier 446 includes documents and/or other search results from a network folder. Accordingly, a show results option 447a may be provided, as well as a go to folder option 447b and a top results option 447c. Similarly, the identifier 448 may identify search results from the remote computing device 108 over the wide area network 101. As such, the identifier may include a show all results option 449a, a homepage option 449b, and a top results option 449c.

It should be understood that in the user interface 430, a plurality of search results were revealed from the search. These results are then rearranged according to the source of the top search results. As an example, the top search result in the user interface 430 was located at my.corp.com. The next top search result was located at SLS (Smart Learning System). As a result, the my.corp.com group was listed first in the user interface 430. With that said, in some embodiments the groups may be organized according to a number of search results and/or according to other criteria. Similarly, the order of the search results within the groups may be made based on the relative rank of the search results within that group. In some embodiments, however, the search results may be ordered within each of the groups according to other criteria.

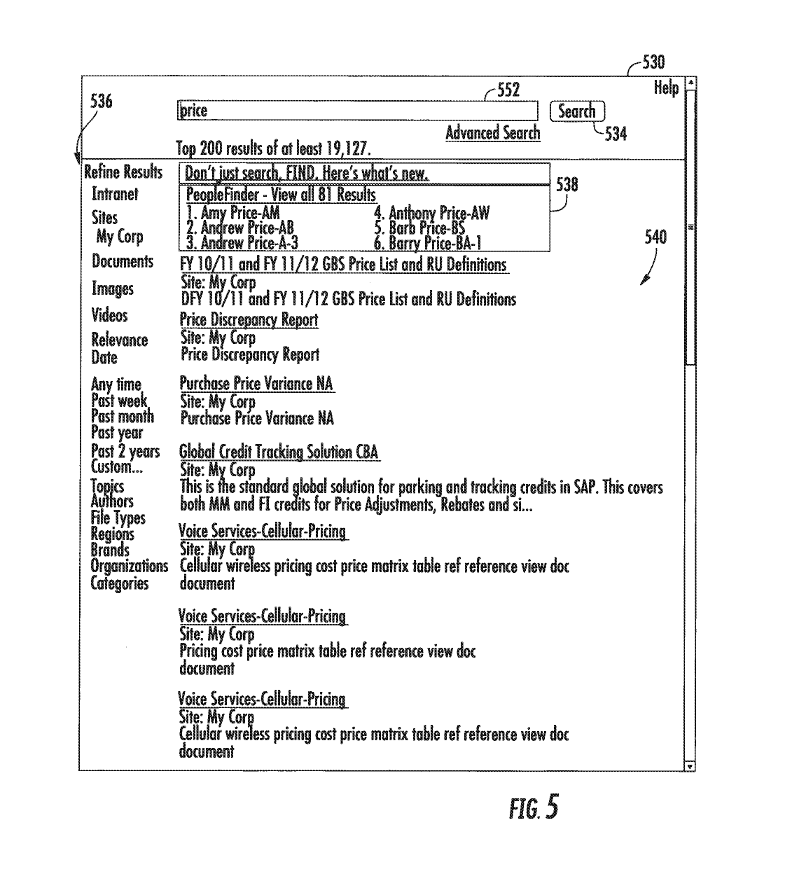

FIG. 5 depicts a user interface 530 for providing filtered search results for a common source, according to embodiments disclosed herein. As illustrated, the user interface 530 includes a keyword section 532 and a search option 534 for initiating a search. Also included is a people finder section 538 for identifying a person that shares information with the search term. A refine results section 536 may include one or more options for refining the search results, such as by site, search result type (e.g., documents, images, and videos), relevance, date, topics, authors, file types, regions, brands, organizations, and categories. Other manual filtering criteria, such as region may also be provided.

Also included in the user interface 530 is a search results section 540. The search results section 540 may be provided in response to selection of the show all option 447a from FIG. 4. Specifically, the user interface 530 provides all the search results from the source my.corp.com. As discussed above, these may be organized according to relevance, date, and/or other criteria.

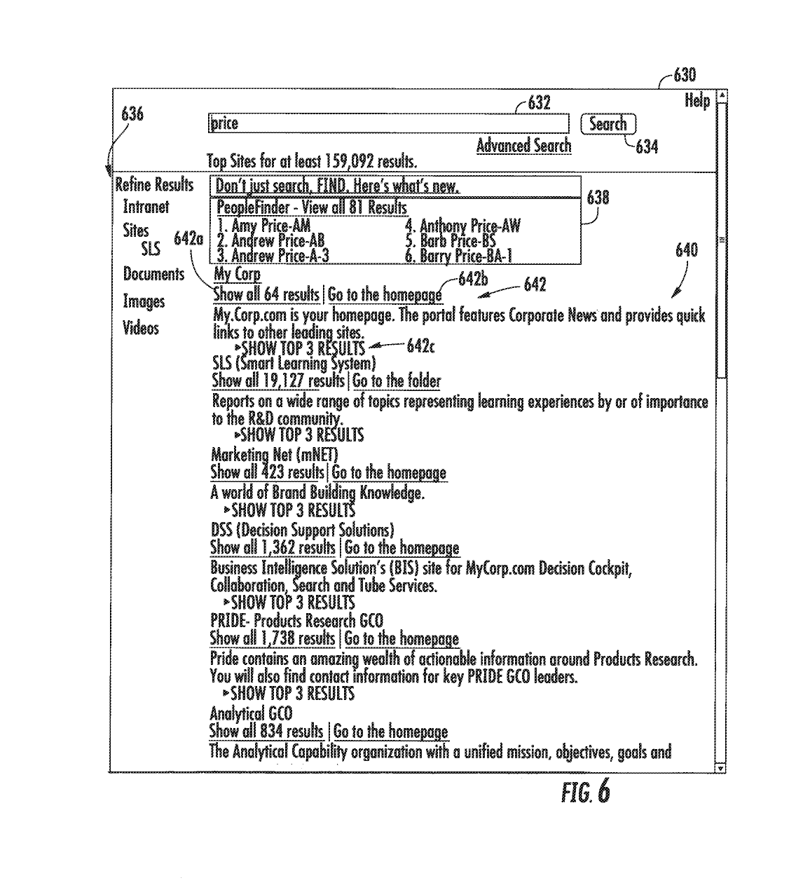

FIG. 6 depicts a user interface 630 for providing sources of search results, according to embodiments disclosed herein. As illustrated, the user interface 630 may include a keyword section 632, a search option 634, a refine results section 636, and a people finder section 638. Also included is a search results section 640 that provides an identifier for each of the groups (sources) of search results from which the search results were located. Specifically, the search result listed first in the user interface 330 from FIG. 3 is located on the my.corp.com site and thus, an identifier 642 for the results is provided as the first listing. Additionally, under the identifier 642 are a show all results option 642a, a go to homepage option 642b, and a top results option 642c. In response to selection of the show all results option 642a, all results from the selected source may be provided, as depicted in FIG. 5. In response to selection of the homepage option 642b, the user may be navigated to the my.corp.com homepage. In response to the top results option 642c, a predetermined number of the top search results may be provided, as depicted in FIG. 4.

It should be understood that the user interface 630 from FIG. 6 provides only the headings of the common sources to the user. As a result, the user may be provided with options to discard entire sources, thereby eliminating large numbers of irrelevant search results. Depending on the embodiment, options for removing sources and/or search results may be provided in the user interfaces described herein.

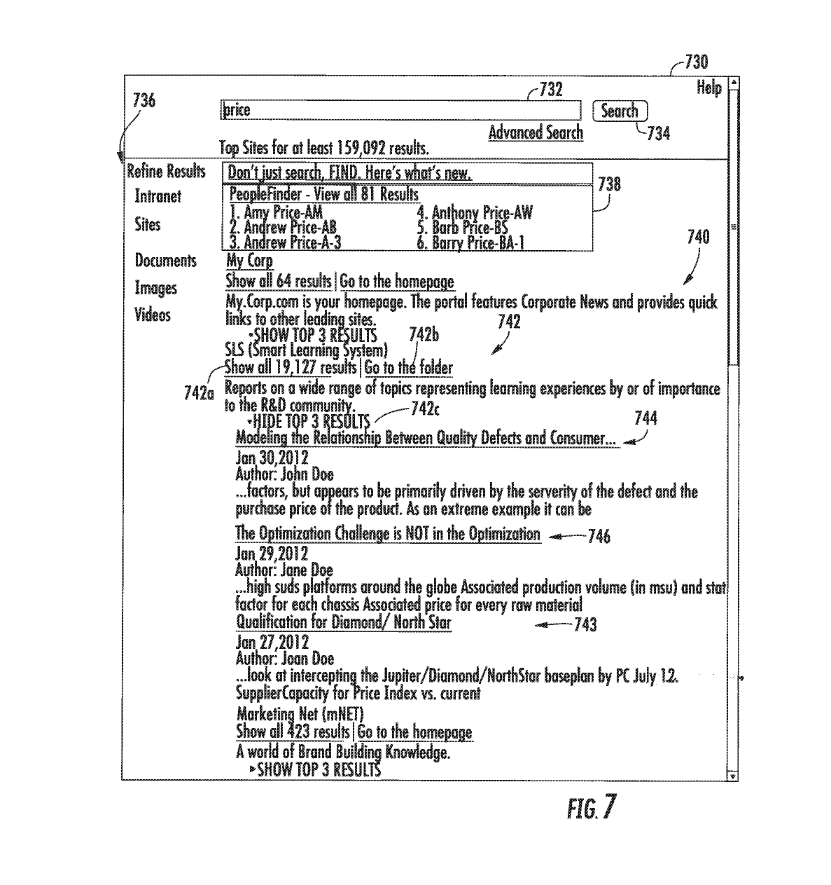

FIG. 7 depicts a user interface 730 for providing primary filtered search results, according to embodiments disclosed herein. As illustrated, the user interface 730 may be provided in response to selection of the top results option 447c from FIG. 4 and includes a keyword section 732, a search option 734, a refine section 736, a people finder section 738, and a search results section 740. Specifically, while the user interface 430 from FIG. 4 depicted organizing search results according to a common site, the user interface 730 depicts organizing search results according to a common computer directory or business group. Accordingly, the SLS (Smart Learning System) group may include over 19,000 search results. By selecting the show all results option 742a, the search results located on that directory may be provided. Similarly, by selecting the folder option 742b, the folder containing the search results may be provided. In response to selecting the hide results option 742c, the search results 744, 746, and 748 may be hidden from view.

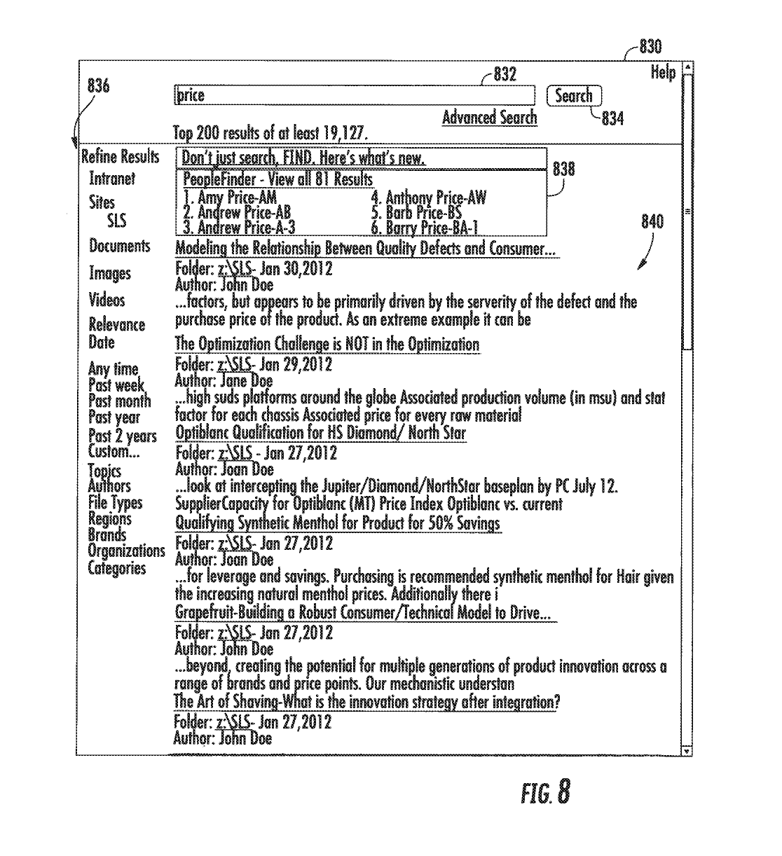

FIG. 8 depicts a user interface 830 for viewing all search results from a source, as selected from a filtered list, according to embodiments disclosed herein. As illustrated, the user interface 830 includes a keyword section 832, a search option 834, a refine section 836, a people finder section 838, and a search results section 840. Similar to the user interface 530 from FIG. 5, the user interface 830 provides the search results that are located at a common source. Thus, the search results section 840 includes the identifiers for the documents from the selected source. Specifically, the folder z:\SLS may include numerous documents and/or other files that related to the received search term. As such, these search results may be organized within the common source according to relevance, date, location, and/or other criteria.

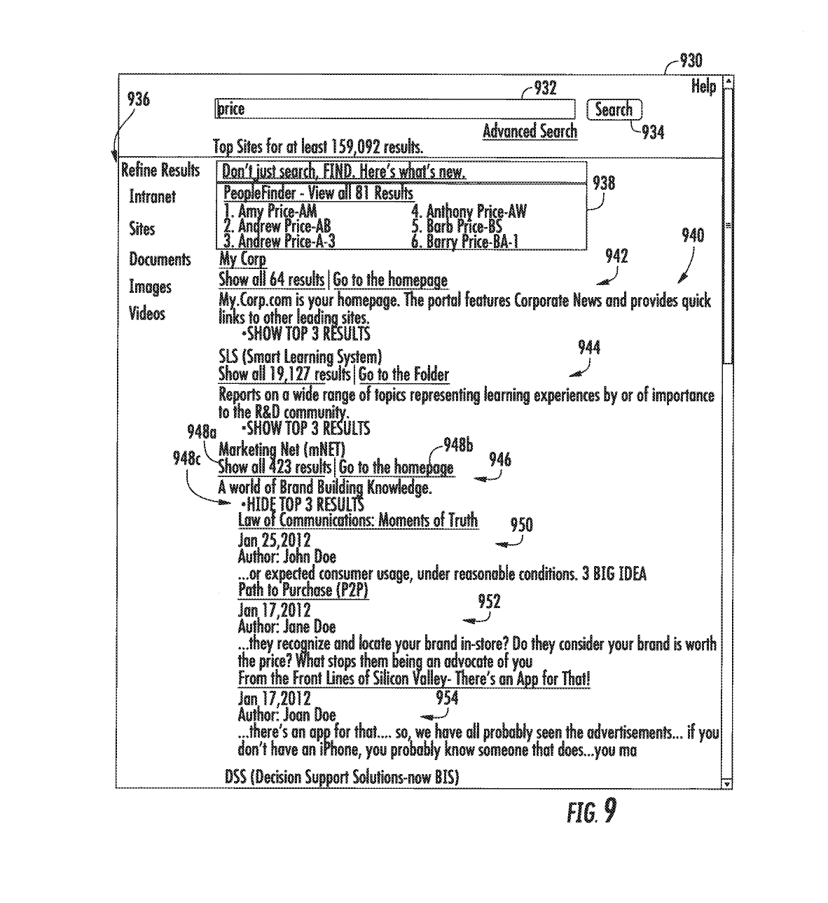

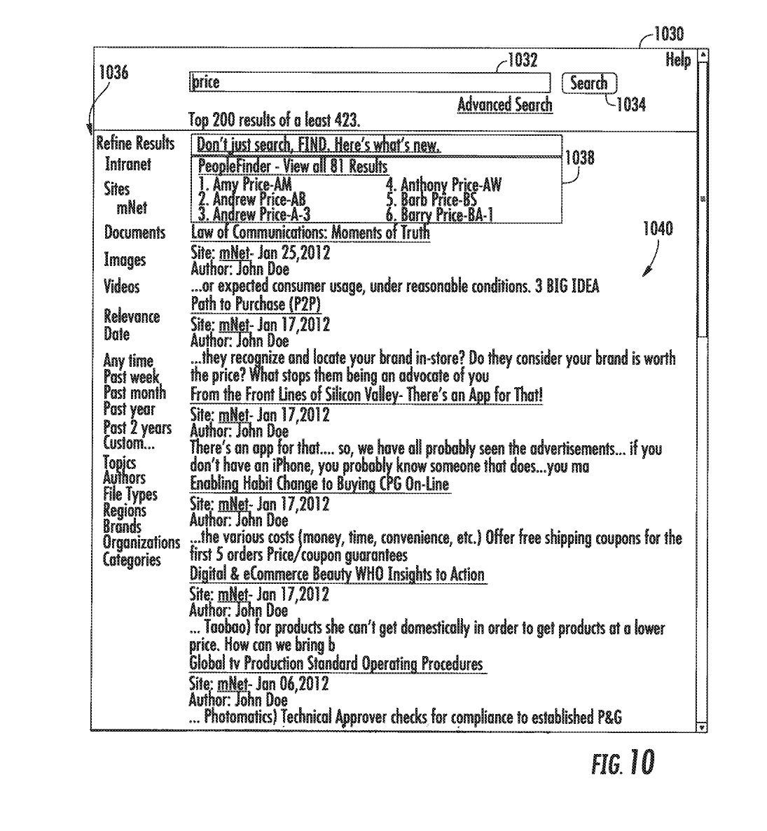

It should be understood that the user interfaces 430 and 530 from FIGS. 4 and 5 provide search results that are located on a local site or intranet site. Similarly, the user interfaces 730 and 830 from FIGS. 7 and 8 provide search results that are located within a folder or directory of the local network 101. The user interfaces 930 and 1030 from FIGS. 9 and 10, however relate to wide area sites, such as websites that are either part of the closed network (e.g., requiring authentication from a user of the closed network and/or part of an open network (e.g., not requiring authentication).

FIG. 9 depicts a user interface 930 for providing top search results from a common source, according to embodiments disclosed herein. As illustrated, the user interface 930 may be provided in response to selection of the top results option 449c from FIG. 4 and includes a keyword section 932, a search option 934, a refine section 936, a people finder section 938, and a search results section 940. As discussed above, the search results section 940 may include an identifier 942 that refers to a local area site. Similarly, the user interface 930 includes an identifier 944 for a local network folder, with a plurality of results being provided within. Also included is an identifier 946 for identifying a group of search results that are stored on the remote computing device 108 and accessed via the wide area network 101. As illustrated, the identifier 946 includes a show all option 948a, a homepage option 948b, and a hide results option 948c. In response to selection of the show all option 948a, the user may be provided with all search results associated with the common source. In response to selection of the homepage option 948b, the user may be directed to the website homepage associated with the source. In response to selection of the hide results option 948c, the search results 950, 952, and 954 may be hidden from view.

FIG. 10 depicts a user interface 1030 for providing all results from a common source, according to embodiments disclosed herein. In response to selection of the show all option 948a from FIG. 9, the user interface 1030 may be provided. As illustrated, the user interface 1030 includes a keyword section 1032, a search option 1034, a refine section 1036, a people finder section 1038, and a search results section 1040. The search results section 1040 may include a plurality of search results that were located on the wide area network site “mNet.” These search results may be organized according to relevance, date, size, result type, and/or other criteria.

It should be understood that the embodiments of FIGS. 4-8 provide context based filtering options to provide search results to users in a comprehendible manner. By grouping search results according to a common source, search results may be explored and/or removed from consideration, thereby reducing the total number of search results that a user needs to view to locate the relevant information.

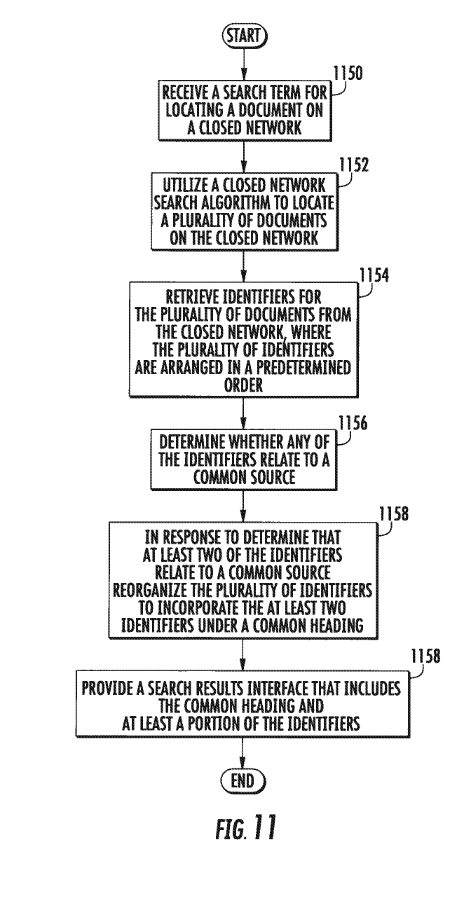

FIG. 11 depicts a flowchart for providing content filtered searching, according to embodiments disclosed herein. As illustrated in block 1150, a search term for locating a document on a closed network may be received. In block 1152, a closed network search algorithm may be utilized to locate a plurality of documents on the closed network. In block 1154, identifiers for the plurality of documents from the closed network may be retrieved. The identifiers may be arranged in a predetermined order. In block 1154, a determination may be made regarding whether any of the identifiers relate to a common source. In block 1156, in response to determining that at least two of the identifiers relate to the common source, the identifiers may be reorganized to incorporate the at least two identifiers under a common heading. In block 1158, a user interface that includes the common heading and at least a portion of the identifiers may be provided.

It should also be understood that some embodiments may provide for grouping of results by site in relevance order and generating a site-based record may be applied to any type of search filter. As an example, if a base author record is created to serve as a focus for grouping, provide an author description, provide contact information, and/or provide a home page, a similar principle may be applied. Other embodiments may also be provided.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be understood to those skilled in the art that various other changes and modifications can be made without departing from the spirit and scope of the invention. It is therefore intended to cover in the appended claims all such changes and modifications that are within the scope of this invention.

What is claimed is:

1. A method for providing context search filtering, comprising:
receiving at least one search term for locating a document on a closed network;
utilizing a closed network search algorithm to locate a plurality of documents on the closed network;
creating identifiers for the plurality of documents from the closed network, the identifiers being arranged in a predetermined order;
determining whether any of the identifiers relate to a common source;
in response to determining that at least two of the identifiers relate to the common source,
reorganizing the identifiers to incorporate the at least two identifiers under a common heading; and
providing a user interface that includes the common heading and at least a portion of the identifiers.

2. The method of claim 1, wherein the closed network is a corporate network.

3. The method of claim 1, further comprising providing only a subset of the at least two identifiers in the user interface.

4. The method of claim 3, further comprising providing an option to view all of the at least two identifiers.

5. The method of claim 1, further comprising providing an option to view a homepage of a network site on the closed network that is associated with the at least two identifiers.

6. The method of claim 1, further comprising performing a person search for the at least one search term and providing an option to view people associated with the closed network that correspond with the at least one search term.

7. The method of claim 1, further comprising providing an option to perform a wide area network search of the at least one search term.

8. A system for providing context search filtering, comprising:
a memory component that stores logic that, when executed by the system, causes the system to perform at least the following:
receive a search term for locating a document on a closed corporate network;
utilize a closed corporate network search algorithm to locate a plurality of documents on the closed corporate network;
determine network locations for the plurality of documents from the closed corporate network;
create user-selectable links for the network locations, the user-selectable links being arranged in a predetermined order;
determine whether any of the network locations relate to a common network location;
in response to determining that at a portion of the network locations relate to the common network location, reorganize the user-selectable links to incorporate the user-selectable links associated with the portion of the network locations under a common heading; and
provide a user interface that includes the common heading and at least a portion of the user-selectable links associated with the common network location.

9. The system of claim 8, wherein the logic further causes the system to provide a filtering option for filtering the plurality of documents based on at least one of the following: relevance, date, topic, author, file type, region, brand, organization, and category of subject matter.

10. The system of claim 8, wherein the logic further causes the system to provide only a subset of the user-selectable links associated with the common network location in the user interface.

11. The system of claim 10, wherein the logic further causes the system to provide an option to view all of the user-selectable links

12. The system of claim 8, wherein the logic further causes the system to provide an option to view a homepage of a network site on the closed corporate network that is associated with the common network location.

13. The system of claim 8, wherein the logic further causes the system to perform a person search for the search term and providing an option to view people associated with the closed corporate network that correspond with the search term.

14. The system of claim 8, wherein the logic further causes the system to provide an option to perform a wide area network search of the search term.

15. A non-transitory computer-readable medium for providing context search filtering that stores logic that causes a computing device to perform the following:
receive a search term for locating a document on a closed corporate network;
utilize a search algorithm to locate a plurality of documents;
determine network locations for the plurality of documents;
create user-selectable links for the network locations, the user-selectable links being arranged in a predetermined order;
determine whether any of the network locations relate to a common network location;
in response to determining that at a portion of the network locations relate to the common network location, reorganize the user-selectable links to incorporate the user-selectable links associated with the portion of the network locations under a common heading; and
provide a USER interface that includes the common heading and at least a portion of the user-selectable links associated with the common network location.

16. The non-transitory computer-readable medium of claim 15, wherein the logic further causes the computing device to provide a filtering option for filtering the plurality of documents based on at least one of the following: relevance, date, topic, author, file type, region, brand, organization, and category of subject matter.

17. The non-transitory computer-readable medium of claim 15, wherein the logic further causes the computing device to provide only a subset of the user-selectable links associated with the common network location in the user interface.

18. The non-transitory computer-readable medium of claim 17, wherein the logic further causes the computing device to provide an option to view all of the user-selectable links.

19. The non-transitory computer-readable medium of claim 15, wherein the logic further causes the computing device to provide an option to view a homepage of a network site on the closed corporate network that is associated with the common network location.

20. The non-transitory computer-readable medium of claim 15, wherein the logic further causes the computing device to perform a person search for the search term and providing an option to view people associated with the closed corporate network that correspond with the search term.
